(19) United States
(12) Patent Application Publication
(10) Pub. No.: US 2020/0092455 A1
(43) Pub. Date: Mar. 19, 2020

(54) CONTROL DEVICE, PHOTOGRAPHING DEVICE, PHOTOGRAPHING SYSTEM, AND MOVABLE OBJECT

(71) Applicant: SZ DJI TECHNOLOGY CO., LTD., Shenzhen (CN)

(72) Inventors: Jiayi ZHANG, Shenzhen (CN); Kenichi HONJO, Shenzhen (CN)

(21) Appl. No.: 16/685,772

(22) Filed: Nov. 15, 2019

Related U.S. Application Data
(63) Continuation of application No. PCT/CN2017/114806, filed on Dec. 6, 2017.

(30) Foreign Application Priority Data
May 24, 2017 (JP) 2017102646

(51) Int. Cl. H04N 5/235; G06T 7/70; H04N 5/225; H04N 5/247; G06K 9/78; B64C 39/02; B64D 47/08

(52) U.S. Cl. CPC H04N 5/2353; G06T 7/70; H04N 5/2253; H04N 5/247; G06K 9/78; B64C 2201/027; B64C 39/024; B64D 47/08; G06T 2207/10032; B64C 2201/127; B64C 2201/146; H04N 5/2351

(57) ABSTRACT

A control device includes a memory storing a program and a processor configured to execute the program to recognize an object from a first image photographed by a photographing device that is in a reference region in a photographing range of the photographing device, predict a reference position of the reference region in a second image to be photographed after the first image is photographed based on driving information for changing a position or an orientation of the photographing device, and control an exposure of the photographing device for photographing the second image based on image data of an image region in the first image corresponding to the reference position in response to the reference position being included in the first image but not on the object.

### CROSS-REFERENCES TO RELATED APPLICATIONS

This application is a continuation of International Application No. PCT/CN2017/114806, filed on Dec. 6, 2017, which claims priority to Japanese Patent Application No. 2017-102646, filed on May 24, 2017, the entire contents of both of which are incorporated herein by reference.

### TECHNICAL FIELD

The present disclosure relates to the field of photographing technology and, more particularly, to a control device, a photographing device, a photographing system, and a movable obj ect.

### BACKGROUND

Japanese patent application publication 2003-43548 discloses a camera that calculates a suitable film sensitivity based on a measurement of luminance of a target object.

### SUMMARY

In accordance with the disclosure, there is provided a control device including a memory storing a program and a processor configured to execute the program to recognize an object from a first image photographed by a photographing device that is in a reference region in a photographing range of the photographing device, predict a reference position of the reference region in a second image to be photographed after the first image is photographed based on driving information for changing a position or an orientation of the photographing device, and control an exposure of the photographing device for photographing the second image based on image data of an image region in the first image corresponding to the reference position in response to the reference position being included in the first image but not on the object.

Also in accordance with the disclosure, there is provided a photographing device including a lens assembly including one or more lenses and a control device. The control device includes a memory storing a program and a processor configured to execute the program to recognize an object from a first image photographed by the photographing device via the lens assembly that is in a reference region in a photographing range of the photographing device, predict a reference position of the reference region in a second image to be photographed after the first image is photographed based on driving information for changing a position or an orientation of the photographing device, and control an exposure of the photographing device for photographing the second image based on image data of an image region in the first image corresponding to the reference position in response to the reference position being included in the first image but not on the object.

Also in accordance with the disclosure, there is provided a photographing system including a photographing device and a support mechanism supporting the photographing device and configured to change an orientation of the photographing device. The photographing device includes a lens assembly including one or more lenses and a control device. The control device includes a memory storing a program and a processor configured to execute the program to recognize an object from a first image photographed by the photographing device via the lens assembly that is in a reference region in a photographing range of the photographing device, predict a reference position of the reference region in a second image to be photographed after the first image is photographed based on driving information for changing a position or an orientation of the photographing device, and control an exposure of the photographing device for photographing the second image based on image data of an image region in the first image corresponding to the reference position in response to the reference position being included in the first image but not on the object.

Also in accordance with the disclosure, there is provided a propulsion system and a photographing system. The photographing system includes a photographing device and a support mechanism supporting the photographing device and configured to change an orientation of the photographing device. The photographing device includes a lens assembly including one or more lenses and a control device. The control device includes a memory storing a program and a processor configured to execute the program to recognize an object from a first image photographed by the photographing device via the lens assembly that is in a reference region in a photographing range of the photographing device, predict a reference position of the reference region in a second image to be photographed after the first image is photographed based on driving information for changing a position or an orientation of the photographing device, and control an exposure of the photographing device for photographing the second image based on image data of an image region in the first image corresponding to the reference position in response to the reference position being included in the first image but not on the object.

### BRIEF DESCRIPTION OF THE DRAWINGS

FIG. 1 is a schematic view of an unmanned aerial vehicle (UAV) and a remote operation device according to an example embodiment of the present disclosure.

FIG. 2 is a functional block diagram of a UAV according to an example embodiment of the present disclosure.

FIGS. 3A-3D are schematic views of relationships between a reference area of an image and an object according to an example embodiment of the present disclosure.

FIGS. 4A-4B are schematic views of relationships between a reference area of an image and an object according to another example embodiment of the present disclosure.

FIG. 5 is a schematic view of relationships between a reference area of an image and an object according to another example embodiment of the present disclosure.

FIG. 6 is a flowchart of a sequence of exposure controls of a photographing device according to an example embodiment of the present disclosure.

FIG. 7 is a flowchart of another sequence of exposure controls of a photographing device according to an example embodiment of the present disclosure.

FIG. 8 is a flowchart of deriving an exposure control value according to an example embodiment of the present disclosure.

FIG. 9 is a hardware block diagram of a control device according to an example embodiment of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

The claims, the description, the drawings, and the abstract of the specification contains matters that are protected by copyright. Anyone who makes copies of these documents as indicated in the documents or records of the Patent Office cannot be objected to by the copyright owner. However, in any other cases, all copyrights are reserved.

The embodiments of the present disclosure can be described with reference to flowcharts and block diagrams. In this case, each of the blocks may represent: (1) a certain stage in an execution process, or (2) a certain circuit of a device executing the process. A recognizable stage or circuit may be implemented by a programmable circuit and/or a processor. The specialized programmable circuits may include digital and/or analog hardware circuits, such as integrated circuits (IC) and/or discrete circuits. The programmable circuits may include re-configurable hardware circuits. The re-configurable hardware circuits may include logical AND gates, logical OR gates, logical XOR gates, logical NAND gates, logical NOR gates, other logical operation gates, flip-flops, registers, field programmable gate arrays (FPGA), programmable logic array (PLA), and other memories.

Computer readable medium may include any tangible devices that can store instructions to be executed by suitable devices. Consequently, the computer readable medium storing the executable instructions may include product including the executable instructions. The executable instructions may be used to implement the operations specified in the flowcharts or block diagrams. For illustrative purposes, the computer readable medium may include an electronic storage medium, a magnetic storage medium, an optical storage medium, an electromagnetic storage medium, or a semiconductor storage medium, such as a floppy disk, a soft magnetic disk, a hard drive, a random-access memory (RAM), a read-only memory (ROM), an erasable programmable read-only memory (EPROM or flash memory), an electrically erasable programmable read-only memory (EEPROM), a static random-access memory (SRAM), a micro-optical read-only memory (CD-ROM), a digital multi-function optical disk (DVD), a blue-ray™ disk, a memory stick, and an integrated circuit module, etc.

The computer readable instructions may include any of source codes or object codes described in any combinations of one or more programming languages. The source codes or the object codes may include existing procedural programming languages. The existing procedural programming languages may include assembly programming languages, instruction set architecture (ISA) instructions, machine instructions, machine-dependent instructions, micro-codes, firmware instructions, state setting data, object-oriented programming languages such as Smalltalk, JAVA™, C++, C programming language, or other similar programming languages. The computer readable instructions may be supplied to a general-purpose computer, a special-purpose computer, or a processor or a programmable circuit of other programmable data processing devices on-site or through a local area network (LAN) or a wide area network (WAN) such as Internet. The processor or the programmable circuit may execute the computer readable instructions to implement the operations specified in the flowcharts or the block diagrams. For illustrative purposes, the processor may include a computer processor, a processing unit, a microprocessor, a digital signal processor, a controller, or a micro-controller, etc.

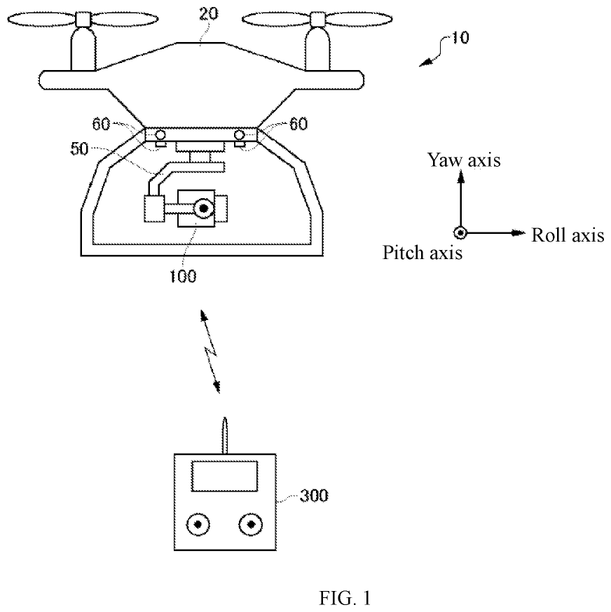

FIG. 1 is a schematic view of an unmanned aerial vehicle (UAV) and a remote operation device according to an example embodiment of the present disclosure. As shown in FIG. 1, the UAV 10 includes a UAV main body 20, a gimbal 50, a plurality of photographing devices 60, and a photographing device 100. The gimbal 50 and the photographing device 100 are one example of a photographing system. The UAV 10 is one example of a movable object propelled by a propulsion system. In some embodiments, the movable object can include another type of flying object capable of moving in the air, a vehicle capable of moving on the ground, or a vessel capable of moving on the water, etc.

The UAV main body 20 includes a plurality of rotors. The plurality of rotors are one example of the propulsion system. The UAV main body 20 can cause the UAV 10 to fly by controlling the rotation of the plurality of rotors. For example, the UAV main body 20 includes four rotors. The number of the rotors may not be limited to four. Further, the UAV 10 may be a rotor-less fixed-wing aircraft.

The photographing device 100 is a camera that photographs target objects within an expected photographing range. The gimbal 50 supports the photographing device 100 by changing the attitude of the photographing device 100. The gimbal 50 supports the photographing device 100 by rotating the photographing device 100. The gimbal 50 is one example of supporting mechanisms. For example, the gimbal 50 supports the photographing device 100 by using an actuator to rotate the photographing device 100 around a pitch axis. The gimbal 50 supports the photographing device 100 by using the actuator to rotate the photographing device 100 around a roll axis and a yaw axis, respectively. The gimbal 50 changes the attitude of the photographing device 100 by rotating the photographing device 100 around at least one of the yaw axis, the pitch axis, or the roll axis.

The plurality of photographing devices 60 are sensing cameras that photograph surroundings of the UAV 10 for controlling flying of the UAV 10. Two photographing devices 60 are disposed on the front of the UAV 10, that is, facing toward the front side. Two additional photographing devices 60 are disposed on the bottom side of the UAV 10. The two front side photographing devices 60 are paired and function as a three-dimensional (3D) camera. The two bottom side photographing devices 60 are also paired and functioned as the 3D camera. Images photographed by the plurality of photographing devices 60 are combined to generate 3D spatial data surrounding the UAV 10. The number of the photographing devices 60 mounted at the UAV 10 is not limited to four. The UAV 10 includes at least one photographing device 60. The UAV 10 may include at least one photographing device 60 at each of the front side, the rear side, the left side, the right side, the bottom side, and the top side of the UAV 10. A configurable viewing angle of the photographing device 60 may be greater than a configurable view angle of the photographing device 100. That is, the photographing range of the photographing device 60 is greater than the photographing range of the photographing device 100. The photographing device 60 may include a fixed focus lens or a fisheye lens.

As shown in FIG. 1, the remote operation device 300 communicates with the UAV 10 to remotely control the operation of the UAV 10. The remote operation device 300 may communicate with the UAV 10 wirelessly. The remote operation device 300 sends driving information to the UAV 10. The driving information includes various driving instructions related to movements of the UAV 10, such as ascending, descending, accelerating, decelerating, advancing, retreating, and rotating, etc. For example, the driving information includes the instruction causing the UAV 10 to ascend. The driving information may indicate a target height of the UAV 10. In response to the instruction, the UAV 10 moves to the target height as indicated by the driving information received from the remote operation device 300.

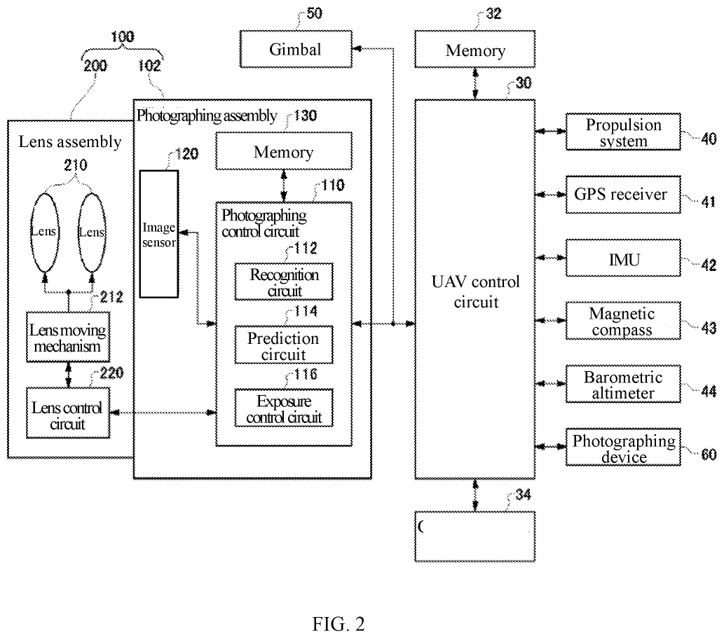

FIG. 2 is a functional block diagram of a UAV according to an example embodiment of the present disclosure. As shown in FIG. 2, the UAV 10 includes a UAV control circuit 30 (UAV controller), a memory 32, a communication interface 34, a propulsion system 40, a GPS receiver 41, an inertial measurement unit (IMU) 42, a magnetic compass 43, a barometric altimeter 44, a gimbal, a photographing device 60, and a photographing device 100.

The communication interface 34 communicates with the remote operation device 300 and other devices. The communication interface 34 receives instruction information. The instruction information includes various instructions from the remote operation device 300 to the UAV control circuit 30. The memory 32 stores programs for the UAV control circuit 30 to control the propulsion system 40, the GPS receiver 41, the IMU 42, the magnetic compass 43, the barometric altimeter 44, the gimbal 50, the photographing device 60, and the photographing device 100. The memory 32 is a computer readable storage medium including at least one of an SRAM, a DRAM, an EPROM, an EEPROM, or a USB flash memory. The memory 32 can be disposed inside the UAV main body 20. The memory 32 may be configured to be removable from the UAV main body 20.

The UAV control circuit 30 controls the flying of the UAV 10 and the photographing according to the programs stored in the memory 32. The UAV control circuit 30 includes a microprocessor such as a CPU or an MPU, or a microcontroller such as an MCU. The UAV control circuit 30 controls the flying of the UAV 10 and the photographing according to the instructions received from the remote operation device 300 through the communication interface 34. The propulsion system 40 propels the UAV 10. The propulsion system 40 includes a plurality of rotors and a plurality of motors for driving the plurality of rotors to rotate. According to the driving instructions from the UAV control circuit 30, the propulsion system 40 uses the plurality of motors to drive the plurality of rotors to rotate, thereby causing the UAV 10 to fly.

The UAV control circuit 30 analyzes a plurality of images photographed by the plurality of sensing photographing devices 60, thereby identifying the environment around the UAV 10. According to the environment around the UAV 10, the UAV control circuit 30 controls the flying, such as avoiding obstacles. Based on the plurality of images photographed by the plurality of photographing devices 60, the UAV control circuit 30 generates the 3D spatial data surrounding the UAV 10 and controls the flying based on the 3D spatial data.

The GPS receiver 41 receives a plurality of signals indicating the time of transmitting from a plurality of GPS satellites. Based on the plurality of received signals, the GPS receiver 41 calculates a position of the GPS receiver 41, that is, a position of the UAV 10. The IMU 42 detects the attitude of the UAV 10. The attitude of the UAV 10 detected by the IMU 42 includes the accelerations in the three axes including a front-rear axis, a left-right axis, and a top-bottom axis, and the angular velocities in the three axial directions of pitch, roll, and yaw axes. The magnetic compass 43 detects orientation of the front of the UAV 10. The barometric altimeter 44 detects the flying height of the UAV 10. The barometric altimeter 44 detects the air pressure surrounding the UAV 10 and converts the detected air pressure into the height, thereby detecting the flying height.

The photographing device 100 includes a photographing assembly 102 and a lens assembly 200. The lens assembly 200 is one example of lens devices. The photographing assembly 102 includes an image sensor 120, a photographing control circuit 110 (photographing controller), and a memory 130. The image sensor 120 may be a CCD or a CMOS image sensor. The image sensor 120 outputs image data of optical images captured by a plurality of lenses 210 to the photographing control circuit 110. The photographing control circuit 110 includes a microprocessor such as a CPU or a MPU or a microcontroller such as a MCU. The photographing control circuit 110 controls the photographing device 100 according to an operation instruction for the photographing device 100 received from the UAV control circuit 30. The memory 130 is a computer readable storage medium including at least one of an SRAM, a DRAM, an EPROM, an EEPROM, or a USB flash memory. The memory 130 stores programs for the photographing control circuit 110 to control the image sensor 120. The memory 130 can be disposed inside the housing of the photographing device 100. The memory 130 may be configured to be removable from the housing of the photographing device 100.

The lens assembly 200 includes a plurality of lenses 210, a lens moving mechanism 212, and a lens control circuit 220 (lens controller). The plurality of lenses 210 may function as a zoom lens, a variable focus lens, or a fixed focus lens. Some or all of the plurality of lenses 210 are configured to move along an optical axis. The lens assembly 200 may be detachable from the photographing assembly 102. The lens moving mechanism 212 moves some or all of the plurality of lenses 210 along the optical axis. According to a lens control instruction from the photographing assembly 102, the lens control circuit 220 drives the lens moving mechanism 212 to make one or more lenses move along the optical axis. The lens control instruction includes, for example, a zoom control instruction and a focus control instruction.

In some embodiments, based on image data in a pre-determined reference region in the photographing range of the photographing device 100, the photographing device 100 controls exposure of the photographing device 100. The photographing device 100 may derive an estimated brightness of the reference region within an image. Based on the estimated brightness, the photographing device 100 drives an exposure control value (EV value). Based on the exposure control value, the photographing device 100 controls the aperture, the shutter speed, and the output gain of the image sensor 120, etc. of the photographing device 100, thereby controlling the exposure of the photographing device 100.

The reference region may be a pre-determined region of interest (ROI) in the photographing range of the photographing device 100 for the purpose of controlling the exposure of the photographing device 100. The reference region may be located in the center of the photographing range of the photographing device 100. The position of the reference region may be pre-determined according to each photographing mode of the photographing device 100. Per user's instruction, the reference region may be configured to be located at any position within the photographing range of the photographing device 100. The shape and size of the reference region vary depending on the photographing mode or the user's instruction. The reference region may include a plurality of sub-regions scattered within the photographing range of the photographing device 100.

Based on the brightness in the reference region of a current image, the photographing device 100 may derive the exposure control value for photographing the next image. Based on the derived exposure control value, the photographing device 100 photographs the next image. The photographing device 100 sequentially photographs images at a pre-determined frame rate. Based on the image data in the reference region of the current frame (or image), the photographing device 100 derives the exposure control value for photographing the next image.

The photographing range of the photographing device 100 mounted at a movable object such as the UAV 10 changes as the UAV 10 moves until the next image is photographed. The photographing range of the photographing device 100 supported by the gimbal 50 changes as the gimbal 50 rotates until the next image is photographed. As such, the brightness within the photographing range changes accordingly. In certain occasions, it is unable to properly control the exposure of the photographing device 100 when the next image is photographed.

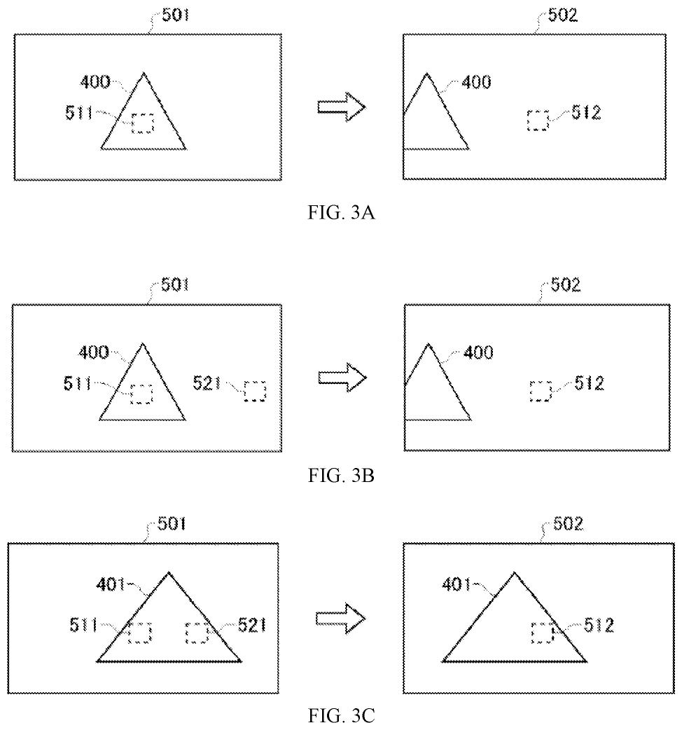

For example, as shown in FIG. 3A, on one hand, the image 501 photographed by the photographing device 100 includes an object 400 and a reference region 511 on the object 400. On the other hand, in the image 502 that the photographing device 100 photographs after the image 501 is photographed, the reference region 512 is not on the object 400. In this case, when the brightness of the object 400 is substantially different from the brightness of the background of the object 400, the photographing device 100 may be unable to properly control the exposure for photographing the image 502 based on the image data of the reference region 511 in the image 501. At this time, if the photographing device 100 photographs the image 502, overexposure or underexposure may occur. For example, while the UAV 10 is flying, the photographing device 100 is photographing high-rise buildings as the object and the sky as the background. If the high-rise buildings are not in the reference region, the overexposure sometimes occurs.

In some embodiments, as shown in FIG. 3B, the photographing device 100 predicts the position of the reference region 512 in the succeeding photographed image 502. When the reference region 512 in the image 502 is included in the image 501 photographed preceding the image 502 and the reference region 512 is not on the object 400, the photographing device 100 controls the exposure of the photographing device 100 for photographing the image 502 based on the image data of an image region 521 in the image 501 corresponding to the reference region 512 in the image 502. As such, if the brightness within the photographing range of the photographing device 100 changes, the exposure of the photographing device 100 may still be properly controlled.

In some embodiments, as shown in FIG. 3C, when the reference region 512 in the image 502 is included in the image 501 and the reference region 512 is on the object 401 that the reference region 511 in the image 501 is also on, the photographing device 100 controls the exposure of the photographing device 100 for photographing the image 502 based on the image data of the reference region 511 in the image 501. When the object 401 including the reference region 511 in the image 501 also includes the reference region 512 in the image 502, the photographing device 100 controls the exposure of the photographing device 100 for photographing the image 502 based on the image data of the reference region 511 in the image 501 and the overexposure or the underexposure may not occur. Thus, in this case, the photographing device 100 has no need to execute a process of moving the reference region, thereby avoiding unnecessary processing load.

In some embodiments, as shown in FIG. 3D, when the image 501 includes the object 402 and the object 403, even if the object 402 does not include the reference region 512 in the image 502, the object 403 sometimes still includes the reference region 512 in the image 502. In this case, similar to FIG. 3C, the photographing device 100 controls the exposure of the photographing device 100 for photographing the image 502 based on the image data of the reference region 511 in the image 501. When the reference region 512 is on another object, the brightness changes less substantially as compared to the circumstance the reference region 512 is not on another object. Thus, when the photographing device 100 controls the exposure based on the image data of the reference region 511 in the image 501, the overexposure or the underexposure is less likely to occur. For example, the photographing device 100 is photographing the high-rise buildings. The high-rise building including the reference region in the current image does not include the reference region in the succeeding image. As long as the reference region in the succeeding image is on another high-rise building, controlling the exposure based on the image data of the pre-determined reference region in the current image may still make the overexposure or the underexposure less likely to occur. Thus, in this case, the photographing device 100 has no need to execute the process of moving the reference region, thereby avoiding the unnecessary processing load.

In some embodiments, to properly control the exposure, the photographing control circuit 110 includes a recognition circuit 112, a prediction circuit 114, and an exposure control circuit 116. The exposure control circuit 116 is one example of control circuits.

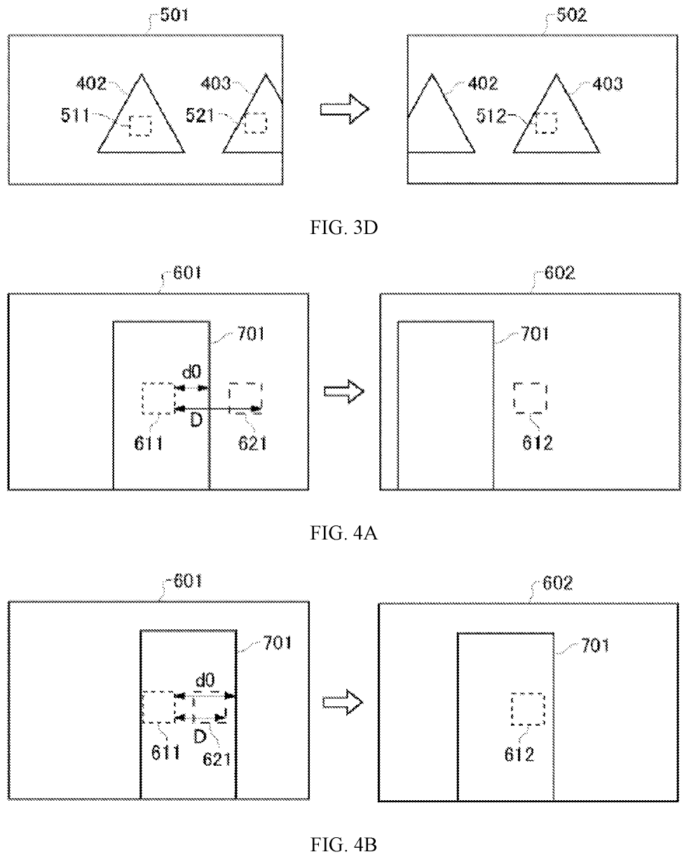

In some embodiments, as shown in FIG. 4A, the recognition circuit 112 is configured to recognize an object 701 in an image 601 photographed by the photographing device 100. A reference region 611 pre-determined within the photographing range of the photographing device 100 is on the object 701. The recognition circuit 112 is capable of recognizing an object within a pre-determined distance from the photographing device 100 as the object 701.

The prediction circuit 114 predicts the position of the reference region 612 in the image 602 photographed succeeding to the image 601 based on driving information for changing the position or orientation of the photographing device 100. Based on the driving information, the prediction circuit 114 determines a movement (movement amount) D of the photographing device 100 from a moment the image 601 is photographed by the photographing device 100 and the moment the image 602 is photographed by the photographing device 100. Based on the movement D, the prediction circuit 114 predicts the position of the reference region 612 in the image 602.

Based on the driving information, the prediction circuit 114 determines a speed of the photographing device 100. Based on the speed and a difference between the moment the image 601 is photographed by the photographing device 100 and the moment the image 602 is photographed by the photographing device 100, the prediction circuit 114 determines the movement D. The prediction circuit 114 determines the speed of the photographing device 100 based on the driving information of the UAV 10 sent by the remote operation device 300. The prediction circuit 114 determines the movement D based on the speed v of the photographing device 100 and the frame rate f (fps) of the photographing device 100. The prediction circuit 114 determines the movement D by calculating v x (1/f).

Based on the driving information, the prediction circuit 114 further determines an orientation change H of the photographing device 100 between the moment the image 601 is photographed by the photographing device 10 and the moment the image 602 is photographed by the photographing device 100. Based on the movement D and the orientation change H, the prediction circuit predicts the position of the reference region 612 in the image 602. The prediction circuit 114 determines the orientation change H of the photographing device 100 based on at least one of the driving information of the UAV 10 sent by the remote operation device 300 or the driving information of the gimbal 50.

As shown in FIG. 4A, when the reference region 612 in the image 602 is included in the image 601 and is not on the object 701, the exposure control circuit 116 controls the exposure of the photographing device for photographing the image 602 based on the image data of the image region 621 in the image 601 corresponding to the reference region 612 in the image 602. As shown in FIG. 4B, when the reference region 612 in the image 602 is on the object 701, the exposure control circuit 116 controls the exposure of the photographing device for photographing the image 602 based on the image data of the reference region 611 in the image 601.

The exposure control circuit 116 may determine a standard movement d0. The standard movement d0 is an expected movement from the moment the image 601 is photographed by the photographing device 100 to the moment the reference region 612 in the image 602 is no longer on the object 701. The standard movement d0 is one example of a first movement (first reference movement amount). When the movement D of the photographing device 100 is greater than or equal to the standard movement d0, the exposure control circuit 116 controls the exposure of the photographing device 100 for photographing the image 602 based on the image data of the image region 621 in the image 601. The exposure control circuit 116 may determine a distance between an end on a photographing device 100 movement direction side of the reference region 611 in the image 601 and an end on the photographing device 100 movement direction side of the object 701 as the standard movement d0. The exposure control circuit 116 may determine the distance between the end on the photographing device 100 movement direction side of the reference region 611 in the image 601 and the farthest end on the photographing device 100 movement direction side of the object 701 as the standard movement d0. The exposure control circuit 116 may determine the distance between the end on the side of the reference region 611 in the image 601 opposite to the photographing device 100 movement direction and the end on the photographing device 100 movement direction side of the object 701 as the standard movement d0.

When at least some reference region 612 in the image 602 is not on the object 701, the exposure control circuit 116 may determine that the reference region 612 in the image 602 is not on the object 701. When the entire reference region 612 in the image 602 is on the object 701, the exposure control circuit 116 may determine that the reference region 612 in the image 602 is on the object 701. When the entire reference region 611 in the image 601 is on the object 701 and a portion of the reference region 612 in the image 602 on the object 701 is smaller than or equal to a pre-determined ratio W, the exposure control circuit 116 may determine that the reference region 612 in the image 602 is not on the object 701. When the entire reference region 611 in the image 601 is on the object 701 and a portion of the reference region 612 in the image 602 on the object 701 is greater than the pre-determined ratio W, the exposure control circuit 116 may determine that the reference region 612 in the image 602 is on the object 701.

For example, when the photographing device 10 moves rapidly, e.g., the UAV 10 moves rapidly, the reference region in the succeeding photographed image sometimes falls outside the current photographing range of the photographing device 100. In this case, it is impossible to determine which object the reference region in the succeeding photographed image is on based on the current image photographed by the photographing device 100. Thus, in this case, the photographing device 100 may control the exposure without moving the reference region.

Further, in addition to the photographing device 100, the UAV 10 also includes the photographing device 60 for photographing in a photographing range different from the photographing device 100. The photographing device 60 functions as the sensing camera for detecting obstacles surrounding the UAV 10. The recognition circuit 112 uses the images photographed by the photographing device 60 to recognize objects outside the photographing range of the photographing device 100.

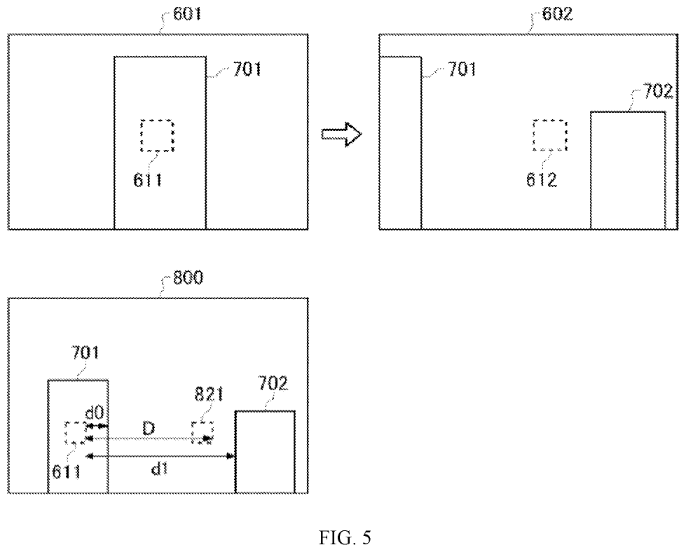

For example, as shown in FIG. 5, the image 800 photographed by the photographing device 60 includes an object 701 and an object 702. On the other hand, the image 601 photographed by the photographing device 100 includes the object 701 but does not include the object 702. Moreover, the image 601 does not include an image region corresponding to the reference region 612 in the image 602 photographed by the photographing device 100 after the image 601 is photographed. On the other hand, the image 800 includes the image region 821 corresponding to the reference region 612 in the image 602. In this case, the photographing device 100 may control the exposure of the photographing device 100 based on the image data pf the image region 821 in the image 800 photographed by the photographing device 60.

Therefore, the recognition circuit 112 may also recognize the object 702. Before the image 602 is photographed, the object 702 exists in the image 800 photographed by the photographing device 60 within a photographing range different from that of the photographing device 100. When the reference region 612 in the image 602 is not included in the image 601 but is included in the image 800, and is not on either the object 701 or the object 702, the exposure control circuit 116 controls the exposure of the photographing device 100 for photographing the image 602 based on the image data of the image region 821 in the image 800 corresponding to the reference region 612 in the image 602. When the reference region 612 in the image 602 is not included in the image 601 but is included in the image 800, and is on either the object 701 or the object 702, the exposure control circuit 116 controls the exposure of the photographing device 100 for photographing the image 602 based on the image data of the reference region 611 in the image 601.

In some embodiments, the characteristics of the image sensor 120 and the lens 210 of the photographing device 100 may be different from the characteristics of the image sensor and the lens of the photographing device 60. In this case, the characteristics of the images photographed by the photographing device 100 may be different from the characteristics of the images photographed by the photographing device 60. Thus, when the exposure of the photographing device 100 is controlled based on the image photographed by the photographing device 60, a correction process can be performed.

When the reference region 612 in the image 602 is included in the image 800 and is not on the object 701 or the object 702, the exposure control circuit 115 controls the exposure of the photographing device 100 for photographing the image 602 based on image data of the image region 821 in the image 800 and a difference between the characteristics of the image photographed by the photographing device 100 and the characteristics of the image photographed by the photographing device 60.

For example, the exposure circuit 116 may perform an interpolation process on the brightness of the image region 821 in the image 800 according to a pre-determined interpolation coefficient. The interpolated brightness is used to derive an evaluation value of the brightness of the image region 821. The derived evaluation value of the brightness is used to derive the exposure control value of the photographing device 100. The interpolation coefficient may be determined based on a difference between the characteristics of the images photographed by the photographing device 100 and the characteristics of the images photographed by the photographing device 60. The photographing device 100 and the photographing device 60 may photograph a same target object. The photographed images are compared to pre-determine the interpolation coefficient.

Based on the driving information, the prediction circuit 114 recognizes the movement D of the photographing device 100 between the moment the image 601 is photographed by the photographing device 100 and the moment the image 602 is photographed by the photographing device 100. Based on the movement D, the prediction circuit 114 predicts the position of the reference region 612 in the image 602. The exposure control circuit 116 recognizes a first standard movement d0 and a second standard movement dl. The first standard movement d0 is an expected movement from the moment the image 602 is photographed by the photographing device 100 to the moment the reference region 612 in the image 602 is no longer on the object 701. The second standard movement dl is an expected movement from the moment the image 601 is photographed by the photographing device 100 to the moment the reference region 612 in the image 602 is on the object 702. When the movement D of the photographing device 100 is greater than the first standard movement d0 and smaller than the second standard movement dl, the exposure control circuit 116 controls the exposure of the photographing device 100 for photographing the image 602 based on the image data of the image region 821 in the image 800. The first standard movement d0 is one example of the first movement. The second standard movement dl is one example of the second movement (second reference movement amount).

When the movement D of the photographing device 100 is smaller than the first standard movement d0 or greater than or equal to the second standard movement dl, the exposure control circuit 116 controls the exposure of the photographing device 100 for photographing the image 602 based on the image data of the reference region 611 in the image 601.

The prediction of the position of the reference region in the succeeding image is performed by the prediction circuit 114 based on the driving information for controlling the UAV 10 or the gimbal 50 before the succeeding image is photographed. Here, after the prediction is made based on the driving information, additional driving information may be used to further control the UAV 10 or the gimbal 50. In this case, the position of the reference region predicted by the prediction circuit 114 may not be accurate. Thus, for example, before the image 602 is photographed by the photographing device 100, other driving information that is different from the previous driving information and is used to change the position or the orientation of the photographing device 100 may be detected. When the reference region 612 in the image 602 is not included in the image 601 and is on the object 701, the exposure control circuit 116 may control the exposure of the photographing device 100 for photographing the image 602 based on the image data of the reference region 611 in the image 601.

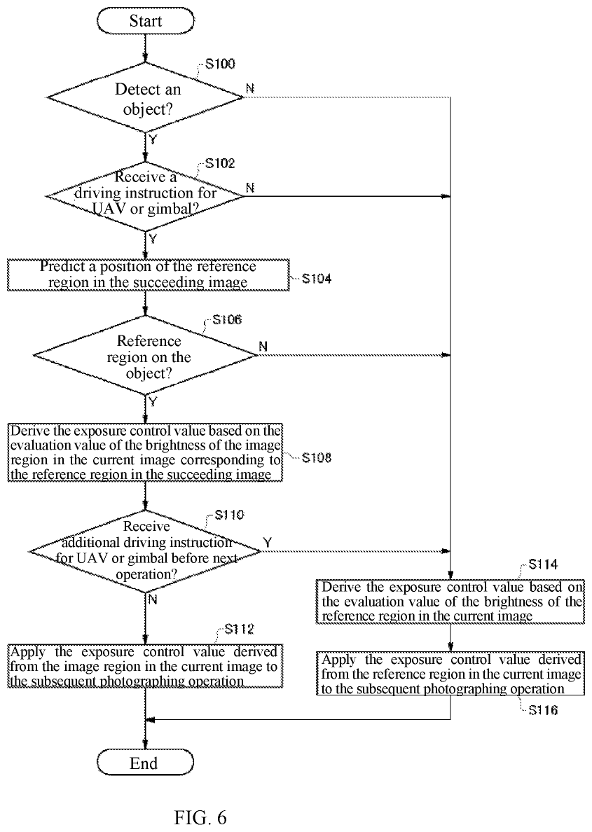

FIG. 6 is a flowchart of a sequence of exposure controls of a photographing device 100 executed by the photographing control circuit 110.

The recognition circuit 112 determines whether an object appears in a reference region in a current image photographed by the photographing device 100 (S100). The recognition circuit 112 may determine whether the object appears in the reference region in the current image based on the presence of anything in the reference region of the current image within a pre-determined distance from the photographing device 100. If no object is in the reference region, the exposure control circuit 116 derives an exposure control value based on an evaluation value of the brightness of the reference region in the current image (S114). Then, the exposure control circuit 116 applies an exposure control value derived from the reference region in the current image to a subsequent photographing operation for photographing a succeeding image (S116).

When the object appears in the reference region in the current image, the prediction circuit 114 determines whether the UAV control circuit 30 receives a driving instruction for the UAV 10 or the gimbal 50 (S102). If no driving instruction is received, the exposure control circuit 116 may apply the exposure control value derived from the reference region in the current image to the subsequent photographing operation for photographing the succeeding image. When the driving instruction for hovering the UAV 10 is received and it is also determined that the UAV 10 is not moving, the exposure control circuit 116 may apply the exposure control value derived from the reference region in the current image to the subsequent photographing operation for photographing the succeeding image.

When the UAV control circuit 30 receives the driving instruction, the prediction circuit 114 determines, based on the driving instruction, a time until the subsequent photographing operation based on the speed of the UAV 10 and the frame rate of the photographing device 100. Based on the speed and the time, the prediction circuit 114 predicts a position of the reference region in the succeeding image (S104).

Then, the exposure control circuit 116 determines whether the reference region in the succeeding image is on the object in the reference region in the current image (S106). When the reference region in the succeeding image is on the object in the reference region in the current image, the exposure control circuit 116 applies the exposure control value derived from the reference region in the current image to the subsequent photographing operation for photographing the succeeding image.

When the reference region in the succeeding image is not on the object in the reference region in the current image, the exposure control circuit 116 derives the exposure control value based on the evaluation value of the brightness of the reference region in the current image corresponding to the reference region in the succeeding image (S108). Then, the exposure control circuit 116 determines whether the UAV control circuit 30 receives any additional driving instruction for the UAV 10 or the gimbal 50 until the subsequent photographing operation (S110). If additional driving instruction is received, the exposure control circuit 116 applies the exposure control value derived from the reference region in the current image to the subsequent photographing operation for photographing the succeeding image. At S110, the UAV control circuit 30 may be driven, for example, after a pre-determined wait time of about one second. This corresponds to an instruction for moving the UAV 10 in a direction different from the initial movement direction. In this case, the reference region 611 is entirely on the object 701, and the exposure does not change.

On the other hand, if no additional driving instruction is received, the exposure control circuit 116 applies the exposure control value derived from the reference region in the current image at 5108 to the subsequent photographing operation for photographing the succeeding image (S112).

As described above, the photographing device 100 predicts the position of the reference region in the succeeding image. If no object appears at the predicted position of the reference region in the succeeding image and the reference region in the current image is on the object, the exposure for photographing the succeeding image is controlled based on the image data of the image region in the current image corresponding to the predicted reference region in the succeeding image. As such, when the brightness within the photographing range of the photographing device 100 changes substantially until the succeeding image is photographed due to the driving of the UAV 10 or the gimbal 50, inappropriate exposure control of the photographing device 100 may be avoided.

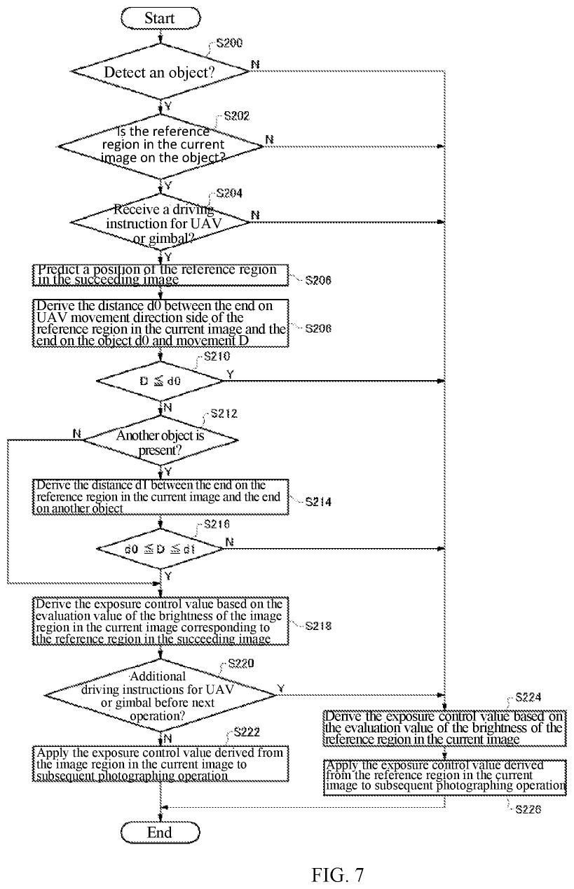

FIG. 7 is a flowchart of another sequence of exposure controls of a photographing device 100 executed by the photographing control circuit 110.

The recognition circuit 112 determines the presence of the object based on the image photographed by the sensing photographing device 60 (S200). If the object is absent, the exposure control circuit 116 derives the exposure control value of the photographing device 100 based on the evaluation value of the brightness of the reference region in the current image (S224). Then, the exposure control circuit 116 applies the exposure control value derived from the reference region in the current image to a subsequent photographing operation for photographing a succeeding image (S226).

When the object is present, the recognition circuit 112 determines whether the object appears in the reference region in the current image photographed by the photographing device 100 (S202). If the object is absent in the reference region in the current image, the exposure control circuit 116 applies the exposure control value derived from the reference region in the current image to the subsequent photographing operation for photographing the succeeding image.

When the object is present in the reference region in the current image, the prediction circuit 114 determines whether UAV control circuit 30 receives the driving instruction for the UAV 10 or the gimbal 50 (S204). If no driving instruction is received, the exposure control circuit 116 applies the exposure control value derived from the reference region in the current image to the subsequent photographing operation for photographing the succeeding image.

When the UAV control circuit 30 receives the driving instruction, the prediction circuit 114 determines, based on the driving instruction, the time until the subsequent photographing operation based on the speed of the UAV 10 and the frame rate of the photographing device 100. Based on the speed and the time, the prediction circuit 114 predicts the position of the reference region in the succeeding image (S206).

The exposure control circuit 116 derives the distance d0 between the end on the UAV 10 movement direction side of the reference region in the current image and the end on the object movement direction side of the reference region and the movement D until the succeeding image is photographed by the photographing device 100 (S208). The exposure control circuit 116 determines whether the movement D is smaller than the distance d0 (S210). If the movement D is smaller than or equal to the distance d0, it is determined that the object is present in the reference region in the succeeding image. As such, the exposure control circuit 116 applies the exposure control value derived from the reference region in the current image to the subsequent photographing operation for photographing the succeeding image.

If the movement D is greater than the distance d0, the exposure control circuit 116 determines whether another object is present (S212). The exposure circuit 116 determines whether another object is present based on a detection result of the object recognized by the recognition circuit 112 based on the image photographed by the photographing device 60. That is, the exposure control circuit 116 determines the presence of the object outside the photographing range of the photographing device 100 in addition to the presence of the object within the photographing range of the photographing device 100.

When no other object is present, the exposure control circuit 116 derives the exposure control value based on the evaluation value of the brightness of either the image region in the current image photographed by the photographing device 100 or the image region in the image photographed by the photographing device 60, corresponding to the reference region in the succeeding image (S218).

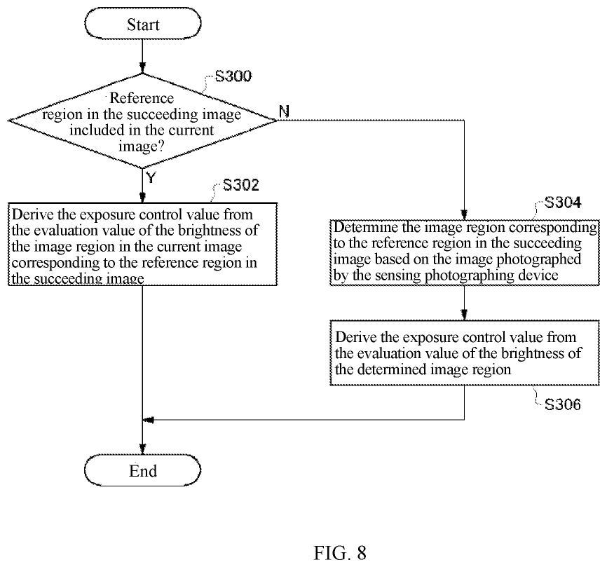

In some embodiments, as shown in FIG. 8, the exposure control circuit 116 determines whether the reference region in the succeeding image is included in the current image photographed by the photographing device 100 (S300). When the reference region in the succeeding image is included in the current image photographed by the photographing device 100, the exposure control circuit 116 derives the exposure control value from the evaluation value of the brightness of the image region in the current image photographed by the photographing device 100 corresponding to the reference region in the succeeding image (S302).

When the reference region in the succeeding image is not included in the current image photographed by the photographing device 100, the exposure control circuit 116 determines the image region corresponding to the reference region in the succeeding image based on the image photographed by the sensing photographing device 60 (S304). The exposure control circuit 116 derives the exposure control value from the evaluation value of the brightness of the image region determined based on the image photographed by the photographing device 60 (S306).

After the exposure control value is derived, the exposure control circuit 116 determines whether the UAV control circuit 30 receives the additional driving instruction for the UAV 10 or the gimbal 50 until the subsequent photographing operation (S220). If the additional driving instruction is received, the exposure control circuit 116 applies the exposure control value derived from the reference region in the current image to the subsequent photographing operation for photographing the succeeding image.

On the other hand, if no additional driving instruction is received, the exposure control circuit 116 applies the exposure control value derived at step 5218 to the subsequent photographing operation for photographing the succeeding image (S222).

The determination result of the step 5212 includes: when another object is present, the exposure control circuit 116 determines the distance dl between the end on the UAV 10 movement direction side of the reference region in the current image and the end on the side of the other object opposite to the movement direction (S214). The exposure control circuit 116 determines whether the movement D is greater than or equal to the distance d0 and smaller than or equal to the distance d1. When the movement D is greater than the distance d1, the exposure control circuit 116 applies the exposure control value derived from the reference region in the current image to the subsequent photographing operation for photographing the succeeding image.

When the movement D is greater than or equal to the distance d0 and smaller than or equal to the distance dl, the exposure control circuit 116 derives the exposure control value based on the evaluation value of the brightness of either the image region in the current image photographed by the photographing device 100 or the image region in the image photographed by the photographing device 60, corresponding to the reference region in the succeeding image (S218). After the exposure control value is derived, the exposure control circuit 116 determines whether the UAV control circuit 30 receives the additional driving instruction for the UAV 10 or the gimbal 50 until the subsequent photographing operation (S220). If the additional driving instruction is received, the exposure control circuit 116 applies the exposure control value derived from the reference region in the current image to the subsequent photographing operation for photographing the succeeding image.

On the other hand, if no additional driving instruction is received, the exposure control circuit 116 applies the exposure control value derived at step 5218 to the subsequent photographing operation for photographing the succeeding image (S222).

As described above, in the photographing device 100 provided by the embodiments of the present disclosure, if the object in the current image photographed by the photographing device 100 or the photographing device 60 is not present in the reference region in the succeeding image, the exposure of the photographing device 100 for photographing the succeeding image is controlled based on the image data of the image region in the current image corresponding to the reference region in the succeeding image. As such, when the brightness within the photographing range of the photographing device 100 changes until the succeeding image is photographed due to the driving of the UAV 10 or the gimbal 50, inappropriate exposure control of the photographing device 100 may be avoided.

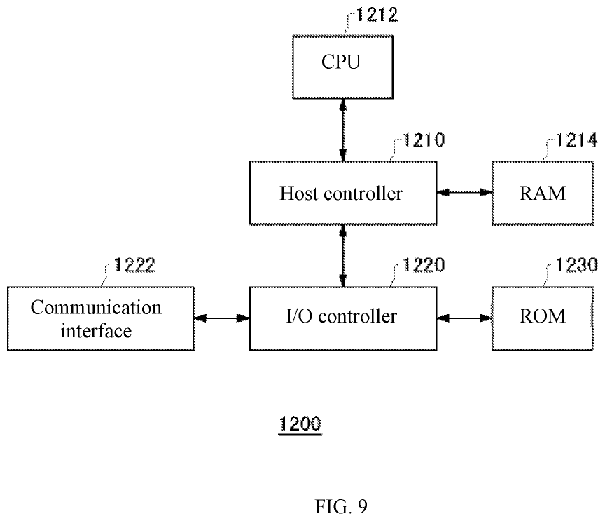

FIG. 9 is a hardware block diagram of a control device according to an example embodiment of the present disclosure. FIG. 9 is an example computer 1200 that implements various aspects of the present disclosure, in whole or in part. The program stored in the computer 1200 enables the computer 1200 to operate as the device provided by the embodiments of the present disclosure or function as one or more circuits of the device. Alternatively, the program enables the computer 1200 to execute the operation or function as one or more circuits. The program enables the computer 1200 to execute the process or the steps of the process of the embodiments of the present disclosure. To execute some or all related operations in the flowchart and the block diagram specified in the specification, the program may be executed by a CPU 1212.

In some embodiments, the computer 1200 includes the CPU 1212 and a RAM 1214. The CPU 1212 and the RAM 1214 are connected to each other by a host controller 1210. The computer 1200 also includes a communication interface 1222 and an input/output circuit. The communication interface 1222 and the input/output circuit are connected to the host controller 1210 through an input/output controller 1220. The computer 1200 also includes a ROM 1230. The CPU 1212 executes the program stored in the ROM 1230 and the RAM 1214 to control other circuits.

The communication interface 1222 communicates with other electronic devices through a network. A hard disk drive can store the program and the data for use by the CPU 1212 of the computer 1200. The ROM 1230 stores a boot program to be executed by the computer at the time of activation and/or a program dependent on the hardware of the computer 1200. The program may be provided through computer readable storage media such as CD-ROM, USB memory or IC card, or through the network. The program may be installed in the computer readable storage media such as the RAM 1214 or the ROM 1230 for execution by the CPU 1212. The program specifies information processing to be retrieved by the computer 1200 for coordination between the program and various types of hardware resources. The device or the method may be constructed by using the computer 1200 to implement the information operation or the information processing.

For example, when the computer 1200 communicates with an external device, the CPU 1212 may execute a communication program loaded in the RAM 1214. Based on the processing described in the communication program, the CPU 1212 instructs the communication interface to perform the communication processing. Under the control of the CPU 1212, the communication interface 1222 retrieves transmission data stored in a transmission buffer provided by the storage medium such as the RAM 1214 or the USB memory, transmits the retrieved transmission data to the network, or writes received data received from the network into a receiving buffer provided by the storage medium.

Moreover, the CPU 1212 may retrieve some or all files or databases stored in an external storage medium such as the USB memory, write into the RAM 1214, and perform various types of processing on the data stored in the RAM 1214. Then, the CPU 1212 may write the processed data back into the external storage medium.

Various types of information such as programs, data, tables, and databases are stored in the storage medium for performing the information processing. The CPU 1212 may execute various types of processing on the data retrieved from the RAM 1214 and write the results back into the RAM 1214. The various types of processing include, but are not limited to, various types of operations, information processing, condition determination, conditional branch, unconditional branch, information retrieval/substitution, that are described in the present disclosure and specified in the program instructions. Moreover, the CPU 1212 may retrieve the information in files and databases in the storage medium. For example, when the storage medium stores a plurality of entries of attribute values of a first attribute related to the attribute values of a second attribute respectively, the CPU 1212 may retrieve an entry from the plurality of entries satisfying a certain condition specified in the attribute values of the first attribute, retrieve the attribute values of the second attribute stored in the entry, and obtain the attribute values of the second attribute related to the first attribute satisfying the pre-determined condition.

The above described program or software may be stored in the computer 1200 or in a computer readable storage medium adjacent to the computer 1200. Moreover, the storage medium such as a hard disk or a RAM provided by a server system connecting to a special-purpose communication network or Internet may be used as the computer readable storage medium. As such, the program may be provided to the computer 1220 through the network.

It should be noted that the processes, the procedures, the steps, and the stages, etc. in the devices, the systems, the program, and the method in the claims, the specification, and the drawings may be executed in any order unless indicated by terms such as “before” and “previous,” etc., or output of a preceding process is used in a succeeding process. For the convenience of illustration, terms such as “first” and “next,” etc., are used in describing a flowchart or procedure in the claims, the specification, and the drawings. However, it does not mean that the flowchart or the procedure must be implemented in this order.

The foregoing descriptions are merely some implementation manners of the present disclosure, but the scope of the present disclosure is not limited thereto. While the embodiments of the present disclosure have been described in detail, those skilled in the art may appreciate that the technical solutions described in the foregoing embodiments may be modified or equivalently substituted for some or all the technical features. And the modifications or substitutions do not depart from the scope of the technical solutions of the embodiments of the present disclosure.

The numerals and labels in the drawings are summarized below.

10 UAV

20 UAV main body

30 UAV control circuit

32 Memory

34 Communication interface

40 Propulsion system

41 GPS receiver

42 IMU

43 Magnetic compass

44 Barometric altimeter

50 Gimbal

60 Photographing device

100 Photographing device

102 Photographing assembly

110 Photographing control circuit

112 Recognition circuit

114 Prediction circuit

116 Exposure control circuit

120 Image sensor

130 Memory

200 Lens assembly

210 Lens

212 Lens moving mechanism

220 Lens control circuit

300 Remote operation device

1200 Computer

1210 Host controller

1212 CPU

1214 RAM

1220 Input/output controller

1222 Communication interface

1230 ROM

What is claimed is:

1. A control device comprising:
a memory storing a program; and
a processor configured to execute the program to:
recognize an object from a first image photographed by a photographing device, the object being in a reference region in a photographing range of the photographing device;
predict a reference position of the reference region in a second image based on driving information for changing a position or an orientation of the photographing device, the second image being to be photographed after the first image is photographed; and
in response to the reference position being included in the first image but not on the object, control an exposure of the photographing device for photographing the second image based on image data of an image region in the first image corresponding to the reference position.

2. The control device of claim 1, wherein the processor is further configured to execute the program to:
in response to the reference position being on the object, control the exposure of the photographing device for photographing the second image based on image data of the reference region in the first image.

3. The control device of claim 1, wherein the processor is further configured to execute the program to:
determine, based on the driving information, a movement amount of the photographing device between a first moment at which the first image is photographed by the photographing device and a second moment at which the second image is to be photographed by the photographing device; and
predict, based on the movement amount, the reference position of the reference region in the second image.

4. The control device of claim 3, wherein the processor is further configured to execute the program to:
determine, based on the driving information, a speed of the photographing device; and
determine the movement amount based on the speed and a time difference between the first moment and the second moment.

5. The control device of claim 3, wherein the processor is further configured to execute the program to:
determine, based on the driving information, an orientation change of the photographing device between the first moment and the second moment; and
determine the reference position based on the movement amount and the orientation change.

6. The control device of claim 3, wherein the processor is further configured to execute the program to:
determine a reference movement amount, the reference movement amount being an expected movement amount from the first moment to a moment at which the reference position is no longer on the object; and
in response to the movement amount of the photographing device being greater than or equal to the reference movement amount, control the exposure of the photographing device for photographing the second image based on the image data of the image region in the first image.

7. The control device of claim 1, wherein:
the object is a first object and the photographing device is a first photographing device; and
the processor is further configured to execute the program to:
recognize a second object from a third image photographed by a second photographing device before the second image is to be photographed by the first photographing device, the second photographing device having a photographing range different from the photographing range of the first photographing device; and
in response to the reference position being not included in the first image but included in the third image, and in response to the reference position being not on the first object or the second object, control the exposure of the first photographing device for photographing the second image based on image data of an image region in the third image corresponding to the reference region in the second image.

8. The control device of claim 7, wherein the processor is further configured to execute the program to:
in response to the reference position being not included in the first image but being included in the third image, and in response to the reference position being on either the first object or the second object, control the exposure of the first photographing device for photographing the second image based on image data of the reference region in the first image.

9. The control device of claim 7, wherein the processor is further configured to execute the program to:
determine, based on the driving information, a movement amount of the first photographing device between a first moment at which the first image is photographed by the first photographing device and a second moment at which the second image is to be photographed by the first photographing device;
predict, based on the movement amount, the reference position of the reference region in the second image;
determine a first reference movement amount and a second reference movement amount, the first reference movement amount being an expected movement amount from the first moment to a moment at which the reference position is no longer on the first object, and the second reference movement amount being another expected movement amount from the first moment to a moment at which the reference position is on the second object; and
in response to the movement amount of the first photographing device being greater than or equal to the first reference movement amount and smaller than the second reference movement amount, control the exposure of the first photographing device for photographing the second image based on the image data of the image region in the third image.

10. The control device of claim 9, wherein the processor is further configured to execute the program to:
in response to the movement amount of the first photographing device being smaller than the first reference movement amount or greater than or equal to the second reference movement amount, control the exposure of the first photographing device for photographing the second image based on image data of the reference region in the first image.

11. The control device of claim 7, wherein the processor is further configured to execute the program to:
in response to the reference position being included in the third image but is not on the first object or the second object, control the exposure of the first photographing device for photographing the second image based on image data of the image region in the third image and a difference between characteristics of the first image and characteristics of the third image.

12. The control device of claim 7, wherein:
the photographing range of the second photographing device is larger than the photographing range of the first photographing device.

13. The control device of claim 1, wherein the processor is further configured to execute the program to:
receive additional different driving information for changing the position or the orientation of the photographing device before the second image is photographed by the photographing device; and
in response to the reference position being included in the first image but not on the object, control the exposure of the photographing device for photographing the second image based on image data of the reference region in the first image.

14. The control device of claim 1, wherein:
the object is a first object; and
the processor is further configured to execute the program to:
recognize a second object from the first image;
in response to the reference position being included in the first image but not on the first object or the second object, control the exposure of the photographing device for photographing the second image based on the image data of the image region in the first image; and
in response to the reference position being on either the first object or the second object, control the exposure of the photographing device for photographing the second image based on image data of the reference region in the first image.

15. The control device of claim 1, wherein:
the driving information is sent from a remote operation device.

16. A photographing device comprising:
a lens assembly including one or more lenses; and
a control device including:
a memory storing a program; and
a processor configured to execute the program to:
recognize an object from a first image photographed by the photographing device via the lens assembly, the object being in a reference region in a photographing range of the photographing device;
predict a reference position of the reference region in a second image based on driving information for changing a position or an orientation of the photographing device, the second image being to be photographed after the first image is photographed; and
in response to the reference position being included in the first image but not on the object, control an exposure of the photographing device for photographing the second image based on image data of an image region in the first image corresponding to the reference position.

17. A photographing system comprising:
the photographing device of claim 16; and
a support mechanism supporting the photographing device and configured to change an orientation of the photographing device.

18. The photographing system of claim 17, further comprising:
another photographing device having a photographing range different from the photographing range of the photographing device.

19. A movable object comprising:
a propulsion system; and
a photographing system including:
a photographing device including:
a lens assembly including one or more lenses; and
a control device including:
a memory storing a program; and
a processor configured to execute the program to:
recognize an object from a first image photographed by the photographing device via the lens assembly, the object being in a reference region in a photographing range of the photographing device;
predict a reference position of the reference region in a second image based on driving information for changing a position or an orientation of the photographing device, the second image being to be photographed after the first image is photographed; and
in response to the reference position being included in the first image but not on the object, control an exposure of the photographing device for photographing the second image based
on image data of an image region in the first image corresponding to the reference position; and
a support mechanism supporting the photographing device and configured to change an orientation of the photographing device.

20. The movable object of claim 19, wherein:
the driving information is sent from a remote operation device.
